(19) United States
(12) Patent Application Publication
(10) Pub. No.: US 2012/0208379 A1
(43) Pub. Date: Aug. 16, 2012

(54) AC INLET

(75) Inventor: Chyi-Lang LAI, Taipei Hsien (TW)

(73) Assignee: Chicony Power Technology Co., Ltd.

(21) Appl. No.: 13/026,481

(22) Filed: Feb. 14, 2011

(51) Int. Cl. H01R 12/00

(52) U.S. Cl. 439/55

(57) ABSTRACT

An AC inlet is electrically connected to a circuit board of an electronic device and includes an insulating body, two electrical conductive pins and two electrical conductive elastic pieces. The insulating body has an insertion trough through which the electrical conductive pins are disposed. The electrical conductive elastic pieces are electrically connected to the two electrical conductive pins and the circuit board. Each electrical conductive elastic piece comprises a connecting portion electrically connected to the electrical conductive pin, a bending portion extending from the connecting portion, and a fixing portion extending from the bending portion to be electrically connected to the circuit board. The elastic deformation of the bending portion protects the electrical connection between the electrical conductive pins and the circuit board. The present invention prevents against solder cracks caused by shaking forces during its removal and plugging. Further, the time and cost for assembly are reduced.

### BACKGROUND OF THE INVENTION

1. Field of the Invention

The present invention relates to an AC inlet, in particular to an AC inlet which is capable of sustaining its repeated removal/plugging and preventing against solder cracks.

2. Description of Prior Art

In order to accommodate different standards of AC cables in many countries, a power adaptor is usually provided with an AC inlet to be electrically connected to other electronic products.

Traditionally, the AC inlet is inserted onto a circuit board of the power adaptor. The conventional AC inlet includes an insulating body. The interior of the insulating body is provided with an insertion trough in which a power cable of an external power source is inserted. The interior of the insertion trough is provided with two electrical conductive pins each connected to a leg by soldering or riveting. The legs extend toward the circuit board and are soldered thereon, so that the two electrical conductive pins can be electrically connected to the circuit board.

However, the above-mentioned AC inlet has some problems. First, both ends of the leg are respectively soldered to the electrical conductive pin and the circuit board, and the leg has poor flexibility. When the power cable is plugged into or removed from the AC inlet for many times, especially the user often removes the power cable from the AC inlet by shaking the power cable first. As a result, the solders between the electrical conductive pins and the legs may suffer cracks easily, which deteriorates the electrical connection there between. Even, the shaking force may also affect the electrical connection between the legs and the circuit board.

Thus, leads are used to electrically connect the AC inlet and the circuit board within an electronic device. If one end of the lead is directly soldered to the electrical conductive pin, the contact area between the lead and the electrical conductive pin is so small that the soldering strength is insufficient. Thus, an electrical conductive piece is additionally provided at the distal end of the electrical conductive pin to increase the contact area between the lead and the electrical conductive pin. The other end of the lead is soldered to the circuit board, thereby achieving the electrical connection between the two electrical conductive pins and the circuit board.

The flexibility of the leads really prevents the solders from cracking during the removal and plugging of the conventional AC inlet. However, both ends of each lead need to be soldered, and each electrical conductive pin has to be connected with an electrical connecting piece. As a result, the time and cost for assembling the conventional AC inlet are higher. Further, the conventional AC inlet has a complicated structure and thus cannot conform to the requirement for compact design.

Therefore, it is an important issue for the present Inventor to solve the above-mentioned problems.

### SUMMARY OF THE INVENTION

The present invention is to provide an AC inlet, which is capable of preventing against solder cracks caused by shaking forces during its removal and plugging. Further, the present invention has a reduced time and cost for assembly.

The present invention provides an AC inlet, electrically connected to a circuit board of an electronic device and including:

an insulating body having an insertion trough;

two electrical conductive pins disposed through the insertion trough; and
two electrical conductive elastic pieces electrically connected to the two electrical conductive pins and the circuit board, each of the electrical conductive elastic pieces comprising a connecting portion electrically connected to the electrical conductive pin, a bending portion extending from the connecting portion, and a fixing portion extending from the bending portion to be electrically connected to the circuit board,

wherein an elastic deformation of the bending portion protects an electrical connection between the electrical conductive pins and the circuit board.

In comparison with prior art, the present invention has the following advantageous features.

The AC inlet of the present invention is provided with the electrical conductive elastic pieces to be electrically connected to the electrical conductive pins and the circuit board. Each of the elastic conductive elastic pieces has a bending portion, and the elastic deformation of the bending portion can protect the electrical connection between the electrical conductive pins and the circuit board. That is, the bending portion can cushion and absorb shaking forces exerted onto the electrical conductive pins by a user during the removal and plugging of the AC inlet.

The middle region of the electrical conductive elastic piece is a bending portion, so that the bending portion generates a cushioning effect to protect the connecting portion and the fixing portion on both ends of the electrical conductive elastic piece, thereby protecting the solders between the connecting portion and the electrical conductive pin as well as the solders between the fixing portion and the circuit board from cracking. Thus, the AC inlet of the present invention eliminates the solder cracks caused by shaking forces during the removal and plugging thereof.

### BRIEF DESCRIPTION OF DRAWING

FIG. 1 is an exploded perspective view of the present invention;

FIG. 2 is an assembled perspective view of the present invention;

FIG. 3 is an assembled perspective view of the present invention from another viewing angle;

FIG. 4 is a cross-sectional view taken along the line 4-4 of FIG. 3;

FIG. 5 is a schematic view showing that an AC inlet of the present invention is electrically connected to a circuit board of an electronic device;

FIG. 6 is a side cross-sectional view of FIG. 5;

FIG. 7 is an exploded perspective view showing a second embodiment of the present invention;

FIG. 8 is an exploded perspective view showing a third embodiment of the present invention;

FIG. 9 is an exploded perspective view showing a fourth embodiment of the present invention; and

FIG. 10 is an exploded perspective view showing a fifth embodiment of the present invention.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

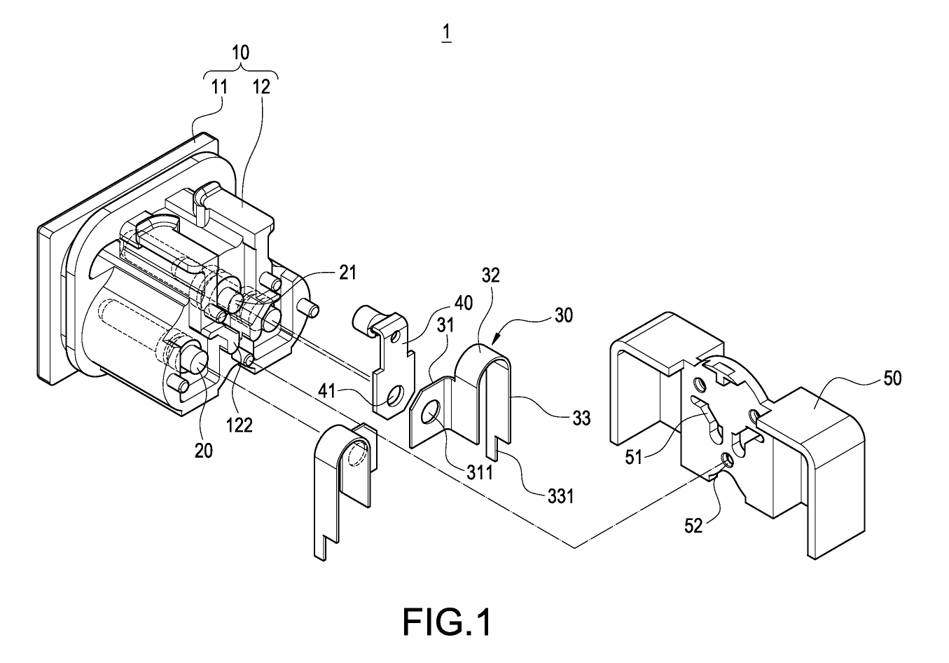

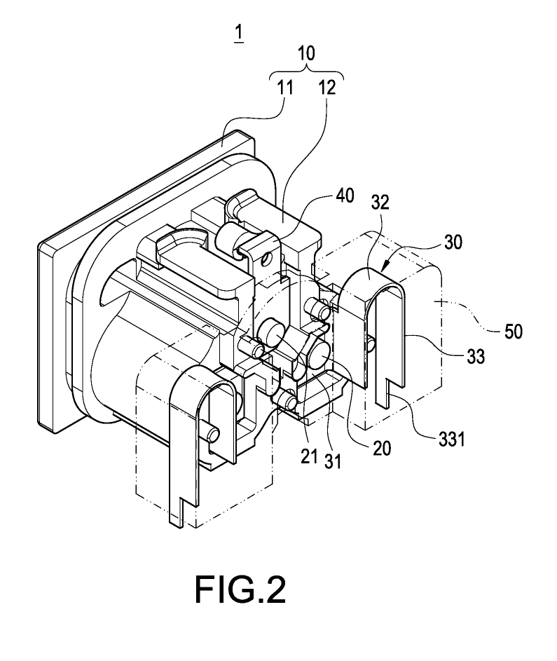

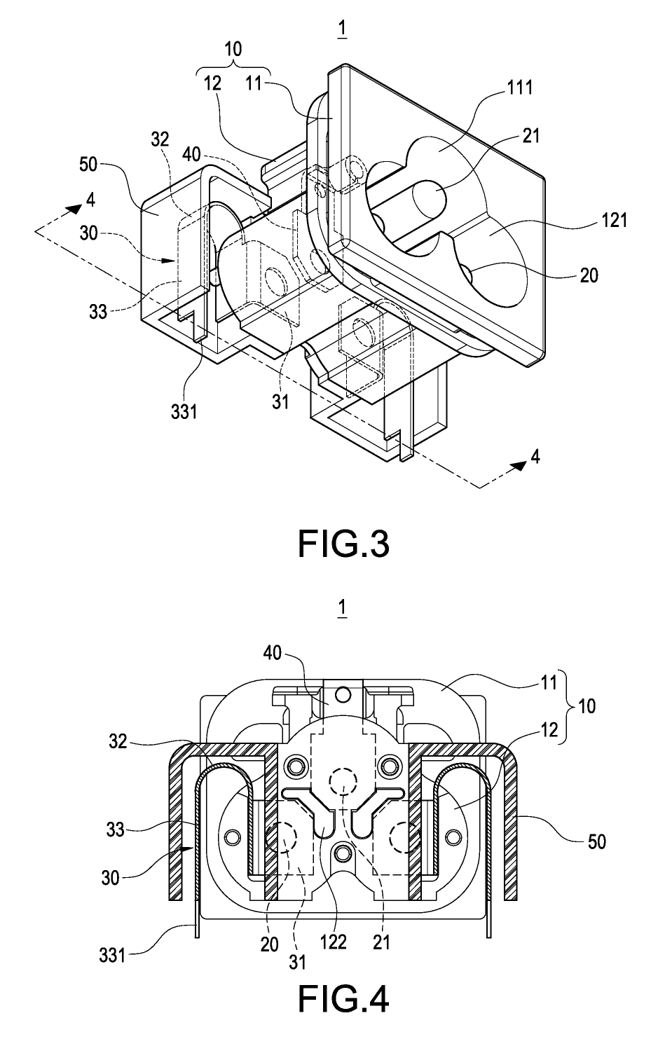

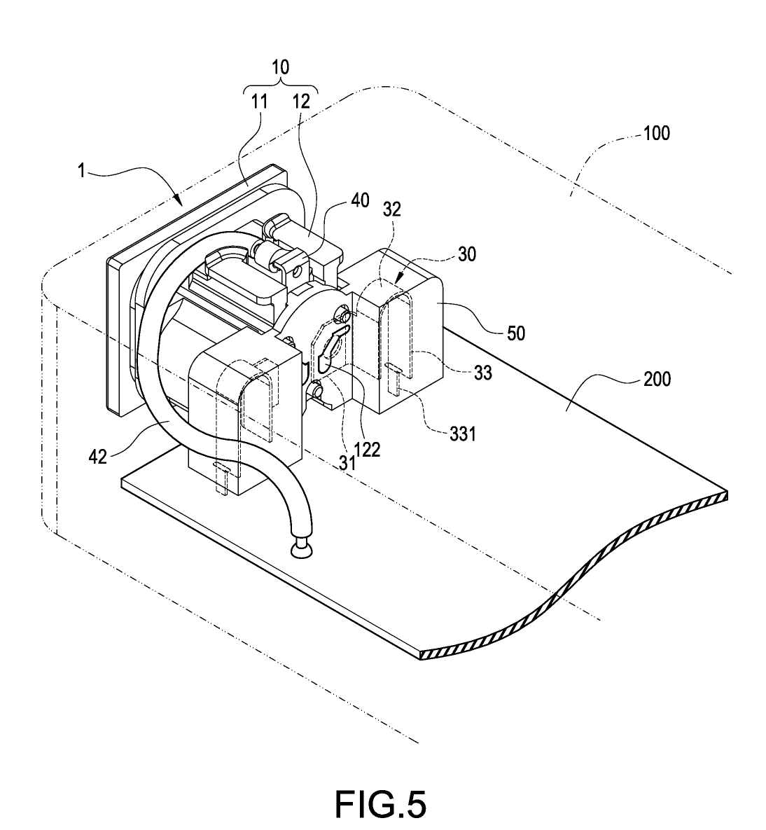

Please refer to FIGS. 1 to 6. The present invention provides an AC inlet 1 electrically connected to a circuit board 200 of an electronic device 100 as shown in FIG. 5. For example, the electronic device 100 may be, but not limited thereto, a power adaptor. The AC inlet 1 includes an insulating body 10, two electrical conductive pins 20 and two electrical conductive elastic pieces 30.

The insulating body 10 is made of insulating material such as plastic. The insulating body 10 is formed with an insertion portion 11 and an accommodating portion 12 connected to the insertion portion 11. The insertion portion 11 has an insertion hole 111 in communication with the outside. The accommodating portion 12 has an insertion trough 121 in communication with the insertion hole 111. The user inserts a power cable (not shown) into the insertion trough 121 via the insertion hole 111.

Each of the electrical conductive pins 20 is made of electrical conductive metal. In the embodiment of FIG. 1, the electrical conductive pin 20 is disposed through the insertion trough 121 of the accommodating portion 12 to penetrate the insulating body 10.

The AC inlet of the present invention further comprises a grounding terminal 21. The grounding terminal 21 is also made of electrical conductive metal and disposed through the insertion trough 121 to penetrate the insulating body 10. In the embodiment of FIG. 1, the grounding terminal 21 is located between the two electrical conductive pins 20. However, the arrangement of the grounding terminal 21 is not limited thereto. In order to electrically connect the grounding terminal 21 to the circuit board 200, the AC inlet 1 of the present invention further comprises an electrical conducting piece 40. One end of the electrical conducting piece 40 is provided with a through hole 41 for allowing the grounding terminal 21 to be disposed through. The other end of the electrical conducting piece 40 has a grounding lead 42 to be electrically connected the circuit board 200 (as shown in FIG. 5).

The two electrical conductive pieces 30 are electrically connected to the two electrical conductive pins 20 and the circuit board 200. More specifically, each of the electrical conductive elastic pieces 30 comprises a connecting portion 31 electrically connected to the electrical conductive pin 20, a bending portion 32 extending from the connecting portion 31, and a fixing portion 33 extending from the bending portion 32 to be electrically connected to the circuit board 200. The connecting portion 31 is provided with a through-hole 311 for allowing the electrical conductive pin 20 to be disposed through and electrically connected to the connecting portion 31. The inner diameter of the through-hole 311 is substantially identical to the outer diameter of the electrical conductive pin 20, so that the electrical conductive pin 20 can be disposed through the through-hole 311 of the connecting portion 31 to be electrically connected to the electrical conductive elastic piece 30. The contact region between the electrical conductive pin 20 and the through-hole 311 may be riveted or soldered to increase the fixing strength there between.

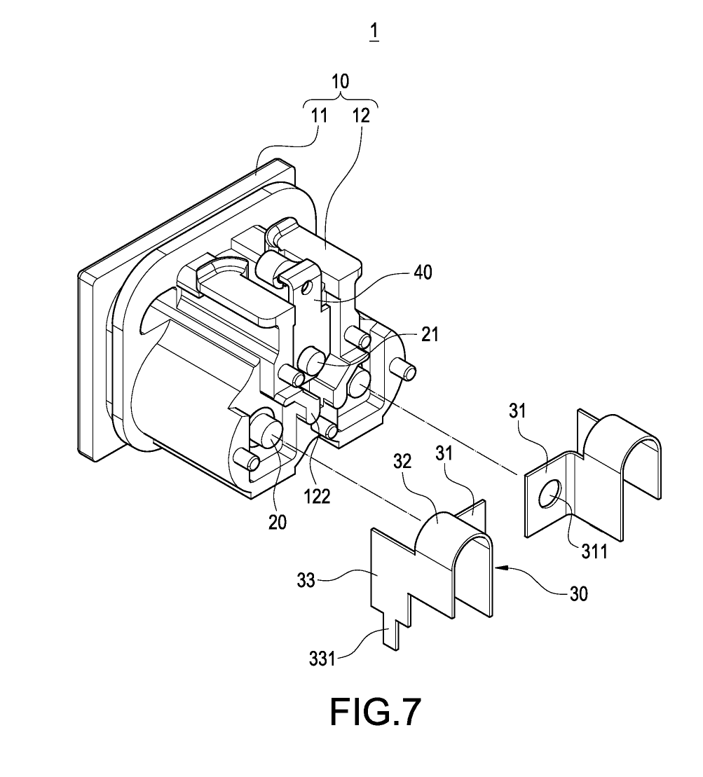

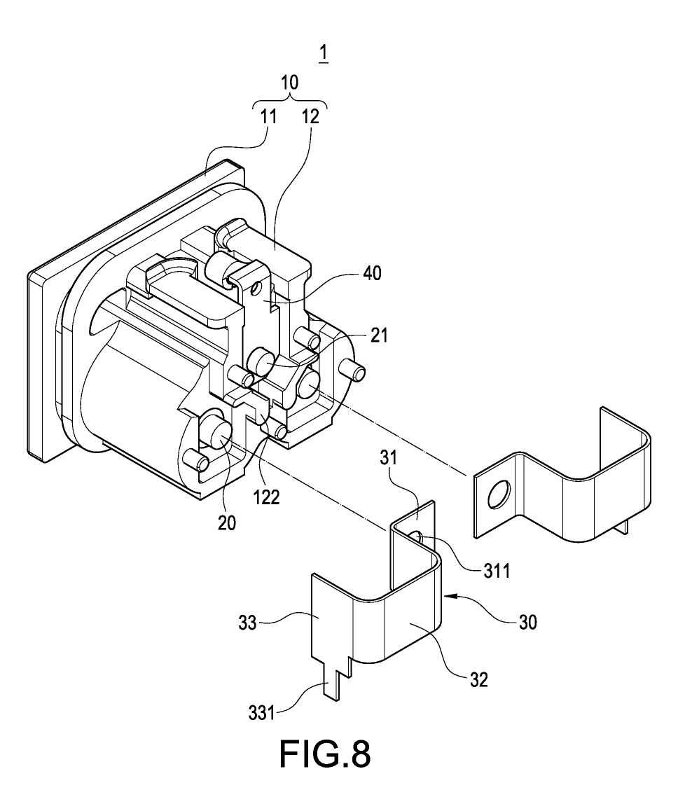

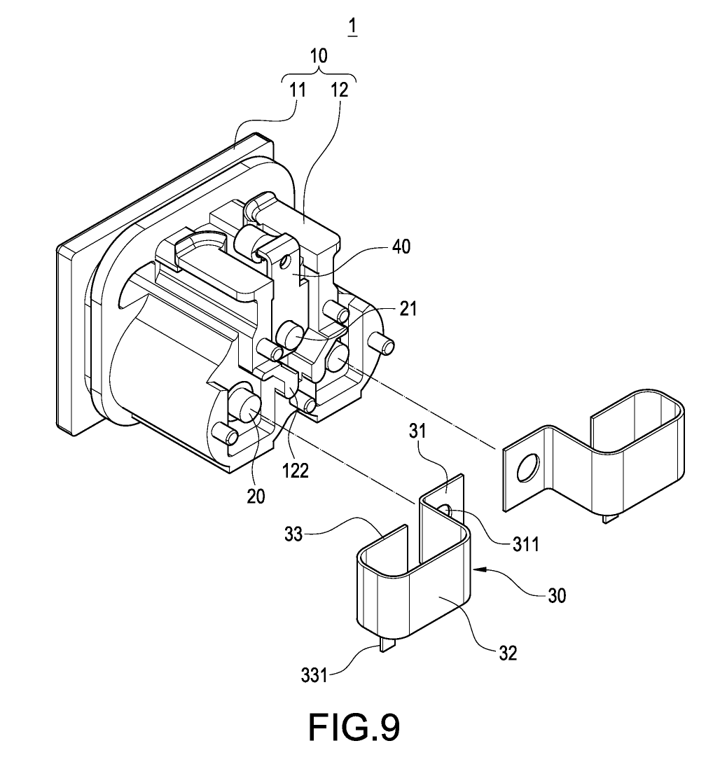

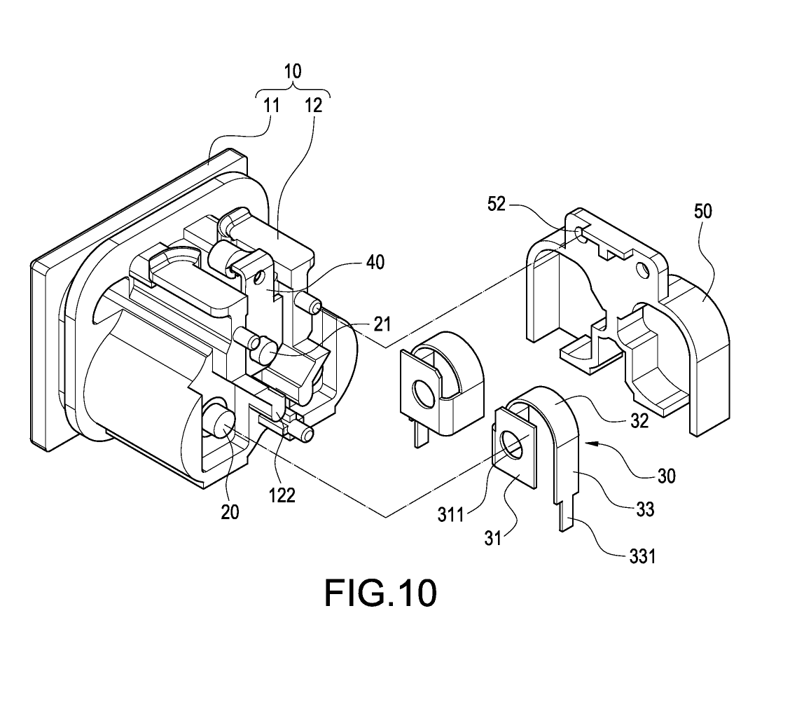

The bending portion 32 has at least one bending section and it can be configured as many shapes based on practical demands. FIGS. 1 and 7 to 10 show five embodiments. The bending portion 32 shown in FIGS. 1 and 7 has one bending section. The bending portion 32 shown in FIG. 8 has two bending sections. The bending portion 32 shown in FIG. 9 has three bending sections. The connecting portion 31 shown in FIGS. 1 to 9 is located outside the bending portion 32, while the connecting portion 31 shown in FIG. 10 is located inside the bending portion 32. Since the elastic deformation of the bending portion 32 serves to protect the electrical connection between the electrical conductive pin 20 and the circuit board 200, the bending portion 32 may be bent into suitable shape based on practical demands. However, the shape of the bending portion 32 is not limited to the above embodiments. For example, the connecting portion 31 may be located one any of the upper, lower, left and right sides of the bending portion 32.

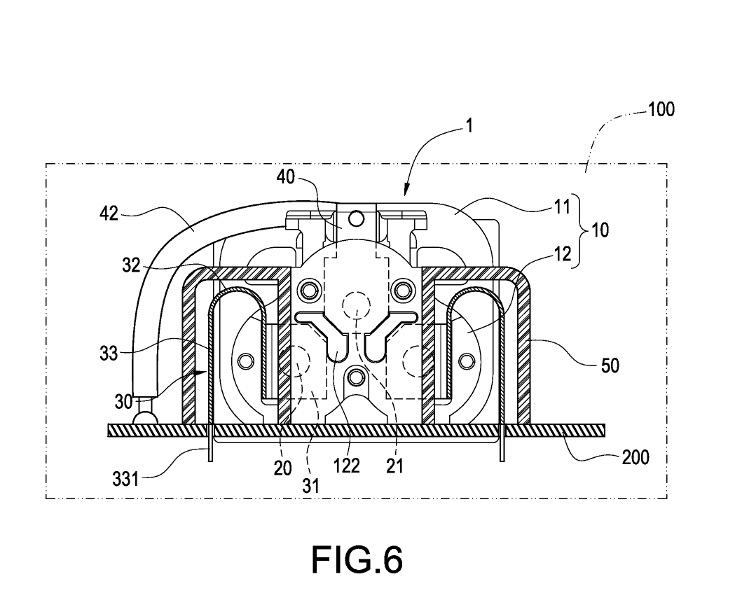

The fixing portion 33 extends from the bending portion 32 to be electrically connected to the circuit board 200. The distal end of the fixing portion 33 is formed with a leg 331. As shown in FIG. 6, the leg 331 is inserted into the circuit board 200 and fixed thereto by riveting, soldering or other suitable ways.

Please refer to FIG. 1 again. The AC inlet 1 of the present invention further comprises a protective shroud 50 connected to the rear end of the insulating body 10, thereby protecting the electrical conductive pins 20, the grounding terminal 21 and the metallic elastic pieces 30. In the embodiment of FIG. 1, the protective shroud 50 is provided with a plurality of holes 51 for allowing the distal ends of the electrical conductive pins 20 and the grounding terminals 21 to be inserted therein. The protective shroud 50 is further provided with two troughs 52 for allowing two engaging ribs 122 formed outside the accommodating portion 12 of the insulating body 10 to be inserted therein. Of course, the assembly between the protective shroud 50 and the insulating body 10 can be carried out by other means.

In comparison with prior art, the present invention has the following advantageous features.

The AC inlet 1 of the present invention is provided with the electrical conductive elastic pieces 30 to be electrically connected to the electrical conductive pins 20 and the circuit board 200. Each of the elastic conductive elastic pieces 30 has a bending portion 32, and the elastic deformation of the bending portion 32 protects the electrical connection between the electrical conductive pins 20 and the circuit board 200. That is, the bending portion 20 can cushion and absorb shaking forces exerted onto the electrical conductive pins 20 by a user during the removal and plugging of the AC inlet 1.

The middle region of the electrical conductive elastic piece 30 is a bending portion 32, so that the bending portion 32 generates a cushioning effect to protect the connecting portion 31 and the fixing portion 33 on both ends of the electrical conductive elastic piece 30, thereby protecting the solders between the connecting portion 31 and the electrical conductive pin 20 as well as the solders between the fixing portion 33 and the circuit board 200 from cracking Thus, the AC inlet 1 of the present invention eliminates the solder cracks caused by shaking forces during the removal and plugging thereof.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

1. An AC inlet, electrically connected to a circuit board of an electronic device and including:
an insulating body having an insertion trough;
two electrical conductive pins disposed through the insertion trough; and
two electrical conductive elastic pieces electrically connected to the two electrical conductive pins and the circuit board, each of the electrical conductive elastic pieces being a one-piece bent plate and comprising a connecting portion provided with a through-hole for allowing the electrical conductive pin to be disposed through to thereby directly and electrically connected to the electrical conductive pin, a bending portion extending from the connecting portion, and a fixing portion extending from the bending portion to be electrically connected to the circuit board,
wherein an elastic deformation of the bending portion protects an electrical connection between the electrical conductive pins and the circuit board.

2. (canceled)

3. The AC inlet according to claim 1, wherein the connecting portion is located on one side of the bending portion.

4. The AC inlet according to claim 3, wherein the bending portion has at least two bending sections.

5. The AC inlet according to claim 3, wherein a distal end of the fixing portion is formed with a leg, the leg is inserted into the circuit board to be fixedly and electrically connected to the circuit board.

6. The AC inlet according to claim 3, further comprising a protective shroud for covering the insulating body to protect the electrical conductive pins and the metallic elastic pieces.

7. The AC inlet according to claim 6, wherein an accommodating portion of the insulating body is formed with two engaging ribs, the protective shroud is provided with two troughs for allowing the engaging ribs to be inserted therein.

8. The AC inlet according to claim 3, wherein the insulating body is formed with an insertion portion and an accommodating portion connected to the insertion portion, the insertion portion has an insertion hole in communication with the outside, the insertion trough is provided in the accommodating portion and in communication with the insertion hole, the AC inlet further comprises a grounding terminal, the grounding terminal is made of electrical conductive metal and disposed through the insertion trough.

9. The AC inlet according to claim 8, further comprising an electrical conductive piece electrically connected the grounding terminal and the circuit board, one end of the electrical conductive piece being provided with a through-hole for allowing the grounding terminal to be disposed through, the other end of the electrical conductive piece having a grounding lead electrically connected to the circuit board.
